(19) United States
(12) Patent Application Publication
(10) Pub. No.: US 2012/0186606 A1
(43) Pub. Date: Jul. 26, 2012

(54) Cleaning of Nozzle Plate

(76) Inventors: Steven H. Barss, Wilmot Flat, NH (US); Paul A. Hoisington, Hanover, NH (US)

(21) Appl. No.: 13/010,159

(22) Filed: Jan. 20, 2011

(51) Int. Cl. B08B 3/00

(52) U.S. Cl. 134/26; 134/94.1

(57) ABSTRACT

A method of cleaning an outer surface of a fluid ejector includes dispensing a cleaning fluid onto the outer surface of the fluid ejector, drying a region of the outer surface of the fluid ejector, and moving the region in a path across the outer surface of the fluid ejector to cause evaporation of the cleaning fluid along a front that moves across the outer surface of the fluid ejector A method of cleaning a surface of a fluid ejector includes dispensing a cleaning fluid onto the outer surface of the fluid ejector, the cleaning fluid including a solvent and carrier liquid that is more wettable to residue of fluid ejected from nozzles of the fluid ejector than the solvent and having a higher vapor pressure than the solvent, and evaporating the carrier liquid such that a concentration of solvent on the surface of the fluid ejector increases.

### TECHNICAL FIELD

This invention relates to cleaning of the a fluid ejector.

### BACKGROUND

A fluid ejector (e.g., an ink jet printhead) typically has one or more nozzles through which fluid is ejected. When fluid is ejected from the nozzles, some fluid can accumulate on an outer surface of the fluid ejector, e.g., due to leakage from the nozzle or due to splash-back from the media being printed upon. If fluid accumulates on the exterior surface next to the nozzle, further fluid ejected from the nozzle orifice can be diverted from an intended path of travel or blocked entirely by interaction with the accumulated fluid (e.g., due to surface tension). In addition, if the fluid dries then a residue, e.g., dried ink, can accumulate in or next to the nozzle, leading to a similar problem.

One technique to counteract accumulation of fluid or residue on the outer surface of the fluid ejector is to periodically clean the nozzle plate, e.g., by wiping the surface of the nozzle plate with an absorbent materials or an elastomeric blade.

Another technique to counteract accumulation of fluid or residue is to coat the outer surface of the fluid ejector with a non-wetting coating, such as a polytetrafluoroethylene (e.g., Teflon®) or other fluorocarbon polymer. However, Teflon® and fluorocarbon polymers typically are soft and are not durable coatings. These coatings also can be expensive and difficult to pattern.

### SUMMARY

As noted above, one cleaning technique is to wipe the outer surface of the nozzle plate. However, wiping of the outer surface of the nozzle plate, particularly at high pressures that might be needed to remove dried ink residue, can damage the nozzles, e.g., chipping the edges of the nozzles. As result, the orifices of the nozzle are no longer smooth, and droplets may be ejected in unintended directions through the orifices. In addition, as noted above, many non-wetting coatings are soft, and can be scraped or damaged by the wiping process, leading to degradation of their non-wetting properties.

A technique that can potentially address this problem is to use a non-contact process to remove residue from the outer surface of the nozzle plate. By dispensing a cleaning fluid onto the outer surface of the nozzle plate, and then driving evaporation of cleaning fluid in a swath across the outer surface of the nozzle plate, residue can be loosened from the nozzle plate surface and transported away from the nozzles without physical contact from a wiper.

Another issue that arises is that many solvents that would be used to clean residue from the surface of the nozzle plate do not adhere to the nozzle plate due to the presence of the non-wetting coating. Thus, the efficacy of the solvent as a cleaner is reduced.

A technique that can potentially address this problem is to dispense a cleaning fluid that includes a solvent and a carrier liquid onto the surface of the nozzle plate. The cleaning fluid can then be heated to evaporate the carrier liquid, thus increasing the concentration of the solvent.

In one aspect, a method of cleaning an outer surface of a fluid ejector includes dispensing a cleaning fluid onto the outer surface of the fluid ejector, drying a region of the outer surface of the fluid ejector, and moving the region in a path across the outer surface of the fluid ejector to cause evaporation of the cleaning fluid along a front that moves across the outer surface of the fluid ejector.

Implementations may include one or more of the following features. Movement of the front across the outer surface of the fluid ejector may carry residue of fluid ejected from nozzles. The region may be linear. The region may extend entirely across the fluid ejector. The path across the outer surface of the fluid ejector may be linear. The region may be elongated along an axis perpendicular to a direction of motion of the front. Drying may include directing a gas at the front. Drying may include heating a portion of the outer surface adjacent the front. Heating the portion of the outer surface may include directing heated gas at the region. Heating the portion of the outer surface may include directing radiant heat at the region. Heating the portion of the outer surface may include generating heat from a heater embedded in the fluid ejector. The cleaning fluid may include a solvent and a carrier liquid. The carrier liquid may have a higher vapor pressure than the solvent. The carrier liquid may be more wettable to residue of fluid ejected by the fluid ejector than the solvent. The cleaning fluid may be collected in a gutter.

In another aspect, a method of cleaning a surface of a fluid ejector includes dispensing a cleaning fluid onto the outer surface of the fluid ejector, the cleaning fluid including a solvent and carrier liquid that is more wettable to residue of fluid ejected from nozzles of the fluid ejector than the solvent and having a higher vapor pressure than the solvent, and evaporating the carrier liquid such that a concentration of solvent on the surface of the fluid ejector increases.

Implementations may include one or more of the following features. The outer surface of the fluid ejector may include a non-wetting coating. The carrier liquid may be more wettable to the non-wetting coating than the solvent. Evaporating the carrier liquid may include heating the cleaning fluid. Heating the carrier liquid may include directing heated gas at the cleaning fluid. Heating the carrier liquid may include directing radiant heat at the cleaning fluid. Heating the carrier liquid may include generating heat from a heater embedded in the fluid ejector. The carrier liquid may be water. The carrier liquid may be partially but not entirely evaporated. The outer surface may be wiped with a contact wiper. A region of the outer surface of the fluid ejector may be dried, and the region in a path across the surface of the fluid ejector may be moved to cause evaporation of the cleaning fluid along a front that moves across the outer surface of the fluid ejector.

In another aspect, an apparatus for cleaning an outer surface of a fluid ejector includes a cleaning fluid dispenser positioned to direct a cleaning fluid onto the outer surface of the fluid ejector, a support to hold the fluid ejector, a drier positioned to dry a region of the outer surface of the fluid ejector held by the support, a motor coupled to at least one of the support or the drier to cause relative motion therebetween such that the region moves in a path across the surface of the fluid ejector, and a controller connected to the drier and the motor to control the relative motion such that the cleaning fluid evaporates along a front that moves across the outer surface of the fluid ejector.

In another aspect, an apparatus for cleaning an outer surface of a fluid ejector includes a dispenser to direct a cleaning fluid onto the outer surface of the fluid ejector, the cleaning fluid including a solvent and carrier liquid that is more wettable to residue of fluid ejected from nozzles of the fluid ejector than the solvent and has a higher vapor pressure than the solvent, and a drier arranged and configured to evaporate the carrier liquid such that a concentration of solvent on the surface of the fluid ejector increases.

Implementations can include one or more of the following advantages. Residue, remnants of the ejected fluid, and other debris can be removed from a region around a nozzle, thus improving printing reliability and accuracy. These materials can be removed without contact (or with contact but at a lower pressure) by an absorbent material or a wiper blade, thus reducing the risk of damage to the nozzle opening or a non-wetting coating, and increasing the life of the printhead. The life of the absorbent material or wiper blade can also be increased. If the materials can be removed without contact, then the maintenance system can be simplified. The likelihood of dragging residue from the surface of the nozzle plate into a nozzles can be reduced.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 illustrates a cross-sectional side view of a fluid ejector.

FIG. 2 illustrates an apparatus for cleaning a fluid ejector.

FIG. 3 is a flowchart of a method of cleaning a fluid ejector.

FIG. 4A is a side view illustrating another implementation of an apparatus for cleaning a fluid ejector.

FIG. 4B is a top view of the apparatus of FIG. 4A.

FIG. 5A illustrates another implementation of an apparatus for cleaning a fluid ejector.

FIG. 5B is a top view of the apparatus of FIG. 5A.

FIG. 6A illustrates a fluid ejector having resistive heaters.

FIG. 6B is a top view of the apparatus of FIG. 6A.

FIG. 7 is a flowchart of another implementation of a method of cleaning a fluid ejector.

FIG. 8 illustrates another implementation of an apparatus for cleaning a fluid ejector.

FIG. 9 illustrates another implementation of an apparatus for cleaning a fluid ejector.

FIG. 10 illustrates another implementation of an apparatus for cleaning a fluid ejector.

Like reference symbols in the various drawings indicate like elements.

### DETAILED DESCRIPTION

Fluid ejector nozzle plates typically need to be cleaned periodically to remove accumulated residue, e.g., ink, or other debris that can impact jetting performance. The surface of the nozzle plate can be washed with a cleaning solution, and then wiped with an absorbent material or an elastomeric blade. However, contacting the nozzle plate can result in damage to the nozzles or the non-wetting coating deposited on the nozzle plate.

Some inks are formulated to be water-soluble when dispensed, but become water-insoluble after drying. If such an ink accumulates on the surface of the nozzle plate, water alone may not be sufficient for cleaning the nozzle plate. In this case, another solvent (i.e., that will tend to dissolve the dried ink) can be added to the cleaning fluid to dissolve and remove the ink. An example of such a solvent is DiEthylene Glycol MonoButyl Ether (DEGmBE); other common solvents can be selected depending on the chemistry of the fluid being ejected. However, without being limited to any particular theory, a problem is that some solvents, e.g., DEGmBE, do not adhere to the nozzle plate due to the presence of the non-wetting coating, and are also less wetting to the ink residue than the cleaning fluid. Consequently, for some cleaning fluids, increasing the concentration of the solvent in the cleaning fluid sprayed onto the nozzle plate does not improve the ability of the cleaning fluid to remove residue, because increasing the concentration of the solvent merely reduces the time for the cleaning fluid to de-wet from the nozzle plate, thus reducing the exposure time of the ink residue to the solvent. For example, a 3:1 solution of water and DEGmBE might take several minutes to de-wet from a nozzle plate with dried ink residue on it, whereas pure DEGmBE might take only seconds to de-wet from such a nozzle plate.

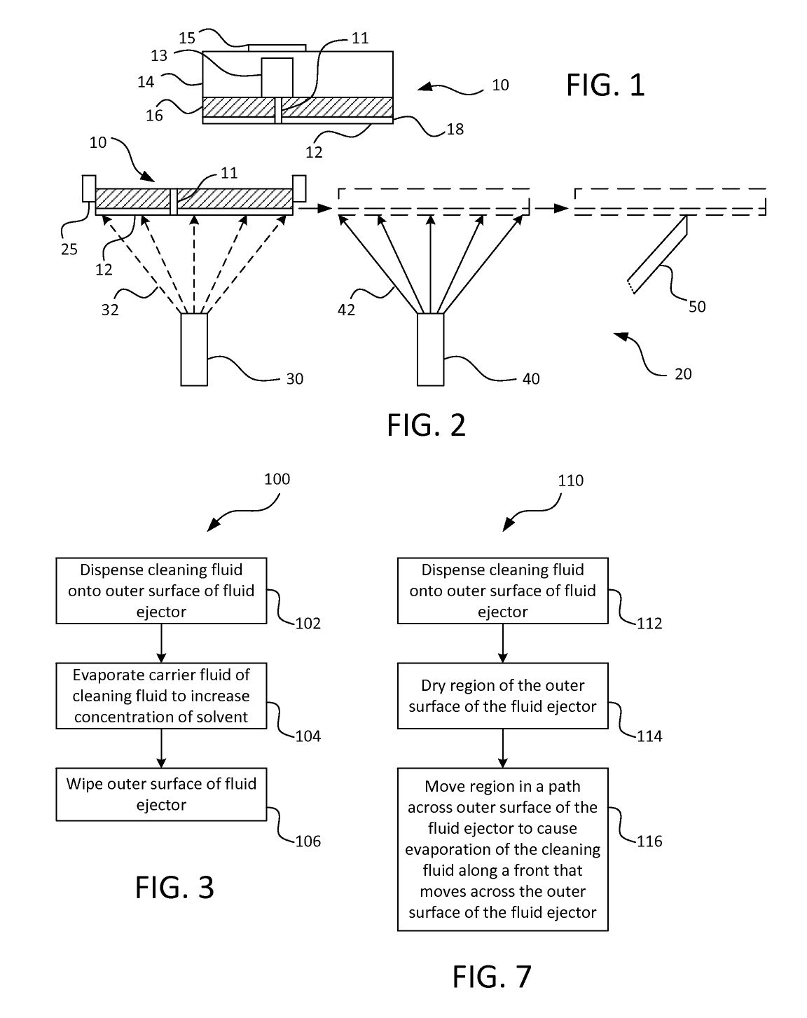

Referring to FIG. 1, a typical fluid ejector 10 has one or more nozzles 11 that extend to an outer surface 12 of the fluid ejector 10. The nozzle 11 can be connected to a pumping chamber 13 formed in the body 14 of the fluid ejector 10, and an actuator 15 to cause fluid, e.g., ink, in the pumping chamber 13 to be ejected through the nozzle 11. The nozzle(s) 11 are formed in a nozzle plate 16, which can be an integral part of the body 14 that includes the pumping chamber 13, or a separate layer that is bonded to the body 14. The nozzle plate 16 can be covered by a non-wetting coating 18.

FIG. 2 illustrates an apparatus 20 for cleaning the outer surface 12 of the fluid ejector 10 (only a lower portion of the fluid ejector 10 is illustrated in FIGS. 2, 4A, 5A, 6A, 8, and 9). The apparatus includes a support 25 to hold the fluid ejector 10, and a dispenser 30 to dispense a cleaning fluid 32 onto the outer surface 12. The cleaning fluid can include a solvent and carrier liquid. The carrier liquid can be more wettable than the solvent to residue formed from dried fluid ejected the fluid ejector (and thus the cleaning fluid containing a mixture of the solvent and the carrier liquid is cleaning fluid wets the residue better than the solvent alone). The solvent can be more or less wettable than the carrier liquid to the non-wetting coating. The carrier liquid can have a higher vapor pressure than the solvent, e.g., the carrier liquid can evaporate at a higher rate than the solvent at the same temperature. The solvent can be DiEthylene Glycol MonoButyl Ether (DEGmBE), although other solvents can be suitable. The carrier liquid can be water, although other carrier liquids can be suitable.

The apparatus 20 also includes a drier 40 to evaporate the cleaning fluid, and more particularly, the carrier liquid of the cleaning fluid. That is, the operating parameters of the drier 40 can be selected so that, due to the lower evaporation temperature of the carrier liquid, the carrier liquid can evaporate faster than the solvent. The drier 40 could partially or entirely evaporate the carrier liquid from outer surface 12 of the fluid ejector 10. However, the solvent should not be entirely evaporated.

The drier 40 can be a radiative heater to direct heat radiation 42 onto the outer surface 12 of the fluid ejector 10. Alternatively, the drier 40 can be a blow drier to direct dry and/or heated gas, e.g., air, onto the outer surface 12 of the fluid ejector 10.

As illustrated in FIG. 2, in some implementations, the dispenser 30 dispenses the cleaning fluid onto all or substantially all of the outer surface 12 of the fluid ejector 10 simultaneously, and the drier 40 evaporates the carrier liquid from all or substantially all of the outer surface 12 simultaneously. However, the dispenser 30 and/or the drier 40 could operate on only a discrete area of the outer surface 12. Relative motion could be generated between the fluid ejector 10 and the dispenser 30 and/or the drier 40, e.g., by a motor connected to at least one of the support 25 or the dispenser 30 and/or drier 40, to cause the discrete area to traverse the outer surface 12. In addition, although FIG. 2 illustrates the fluid ejector 10 as moving from the dispenser 30 to the drier 40, the fluid ejector 10 could remain stationary and the dispenser 30 and drier 40 could be moved.

The system 20 can also optionally include a contact wiper 50, such as an absorbent material or an elastomeric blade. After the carrier liquid has been at least partially evaporated, the contact wiper 50 can wipe the remaining residue from the outer surface 12 of the fluid ejector 10. Again, the wiper 50 could move across the outer surface 12, or the wiper 50 could remain stationary while the fluid ejector 10 moves.

FIG. 3 illustrates a flow chart for a method 100 of operating the system 20. The cleaning fluid 32 is dispensed onto the outer surface 12 of the fluid ejector (step 102). The cleaning fluid 32 can include a solvent, e.g., DEGmBE, and a carrier liquid, e.g., water, that is more wettable to residue of fluid ejected from nozzles of the fluid ejector than the solvent (and thus the cleaning fluid containing a mixture of the solvent and the carrier liquid is cleaning fluid wets the residue better than the solvent alone). The carrier liquid can have a higher vapor pressure than the solvent, e.g., the carrier liquid can evaporate at a higher rate than the solvent at the same temperature. The carrier liquid is evaporated such that a concentration of solvent on the surface of the fluid ejector increases (step 104). Optionally, the outer surface 12 of the fluid ejector 10 can then be wiped, e.g., by an absorbent material or an elastomeric blade 50 (step 106).

Without being limited to any particular theory, by dispensing a cleaning fluid that includes a solvent and a carrier liquid onto the surface of the nozzle plate, and then evaporating the carrier liquid, solvent can be concentrated at the residue. This can loosen the residue such that the residue can be removed by the contact wiper 50 at lower pressure, or potentially cause the residue to detach from the outer surface 12 of the nozzle plate 16 entirely (in which case the contact wiper 50 may not be necessary).

Another effect that can be used to enhance cleaning of a fluid ejector is evaporation of the cleaning fluid in a wave that moves across the outer surface of the fluid ejector. A wide variety of techniques can be used to create this effect.

In general, the system can include a dispenser to dispense cleaning fluid onto the outer surface, and a drier, e.g., a blow drier, external radiant heater, or internal resistive heater, to dry a region of the outer surface of the fluid ejector.

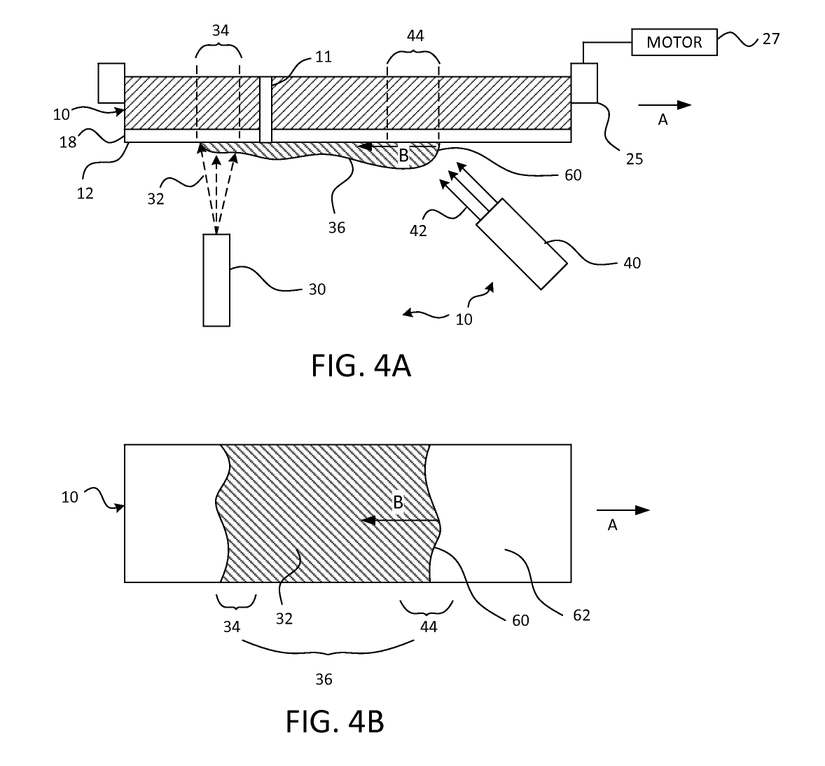

Referring to FIGS. 4A and 4B, in some implementations, the system 20 for cleaning the outer surface 12 of the fluid ejector 10 includes the support 25 to hold the fluid ejector 10, and the dispenser 30 to dispense the cleaning fluid 32. The dispenser 30 dispenses the cleaning fluid 32 onto a region 34 of the outer surface 12, and fluid ejector 10 can move relative to the dispenser 30 (shown by arrow A) so that an area 36 of the outer surface 12 is coated by the cleaning fluid 32.

The system 20 also include a blow drier 40 to direct dry and/or heated gas 42 at a region 44 of the outer surface 12 of the fluid ejector 10. The gas 42 can be air, pure nitrogen, or a noble gas. The fluid ejector 10 moves relative to the blow drier 40 (shown by arrow A) so that the region 44 sweeps across the outer surface 12. The blow drier 40 can include a plurality of nozzles arranged in a line perpendicular to the direction of relative motion A that spans the fluid ejector 10. The direction of flow of gas 42 from the blow drier 40 can be an acute angle relative to the outer surface 12.

By selecting an appropriate relative speed between the fluid ejector 10 and the blow drier 40, in conjunction with a temperature and intensity of the gas from the blow drier 40, the cleaning fluid 32 is completely evaporated from the outer surface 12 along a front 60. And because the fluid ejector 10 moves relative to the blow drier 40, the front 60 will sweep across the outer surface 12 (shown by arrow B).

Without being limited to any particular theory, due to the surface tension at the front 60 of the cleaning fluid and/or the Marangoni flow of the cleaning fluid away from the front 60, residue on the outer surface 12 that has been loosened by the solvent in the cleaning fluid can be carried along by the moving front 60, thus leaving a very clean region 62 of the outer surface 12 in its wake. Consequently, the outer surface 12 can be cleaned without a contact wiper.

Relative motion can be generated between the fluid ejector 10 and the blow drier 40 by a motor 27 connected to at least one of the support 25 or the blow drier 40.

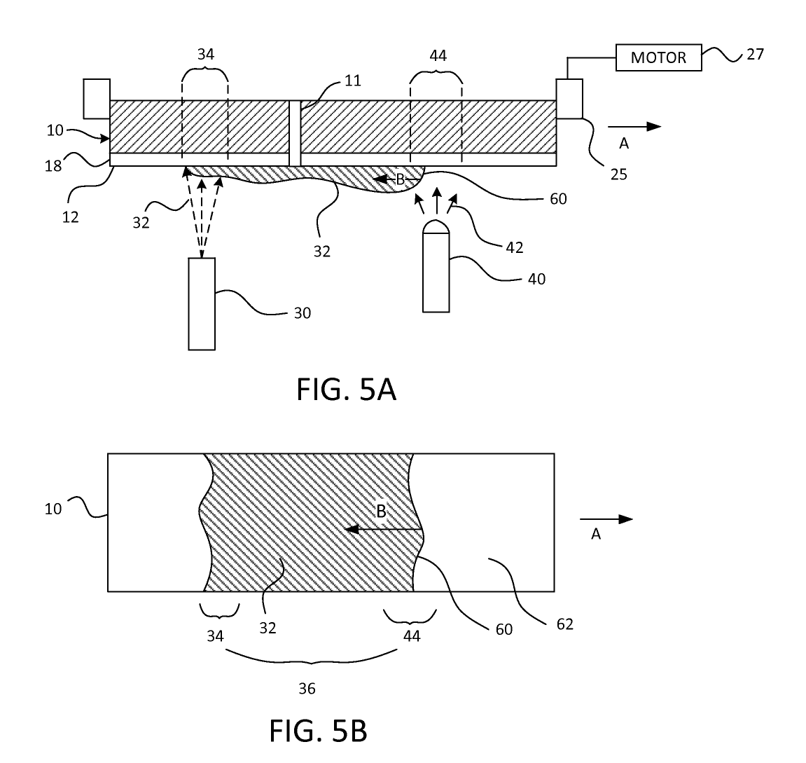

Referring to FIGS. 5A and 5B, in some implementations, alternatively or in addition to a blow drier, the apparatus 20 includes an external heater 40 to apply heat to a region 44 of the outer surface 12 of the fluid ejector 10. The external heater 40 can be a radiating heater that radiates infrared radiation 42 onto the region 44. The external heater 40 can be spaced from the fluid ejector 10 by a small gap so that no contact occurs between the external heater 40 and the fluid ejector 10.

By selecting an appropriate relative speed and distance between the fluid ejector 10 and the external heater 40, in conjunction with a temperature of the external heater 40, the cleaning fluid 32 is completely evaporated from the outer surface 12 along a front 60. And because the fluid ejector 10 moves relative to the external heater 40, the front 60 will sweep across the outer surface 12 (shown by arrow B).

Relative motion can be generated between the fluid ejector 10 and the external heater 40 by a motor 27 connected to at least one of the support 25 or the external heater 40.

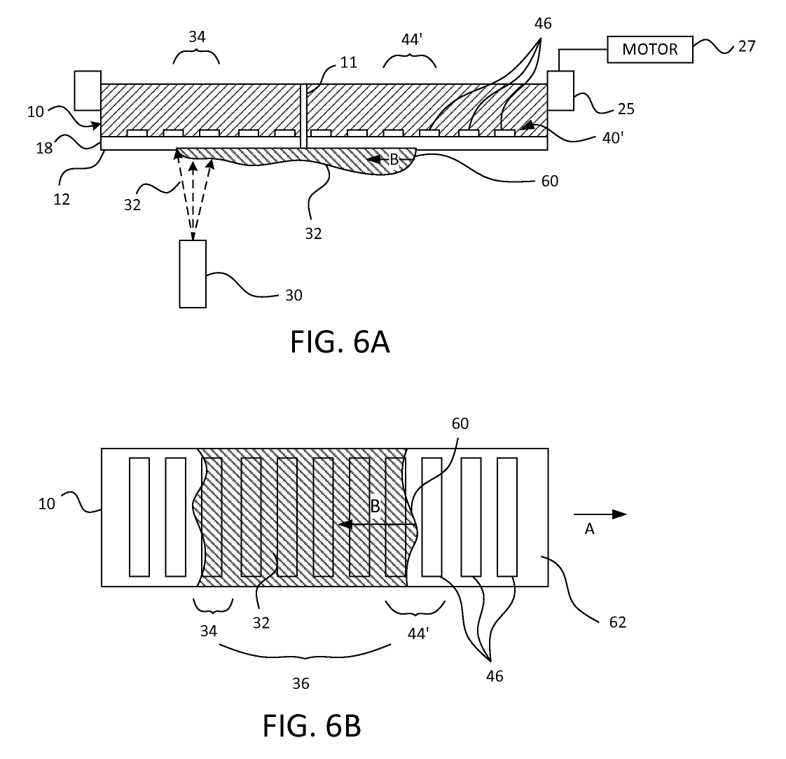

Referring to FIGS. 6A and 6B, in some implementations, alternatively or in addition to a blow drier and/or external heater, the fluid ejector 10 includes an internal heater 40′ to heat of the outer surface 12 of the fluid ejector 10. The internal heater 40′ can include multiple individually controllable heating elements 46, e.g., a series of thin film resistors laminated on or under the nozzle plate 16 of the fluid ejector 10, e.g., below the non-wetting coating 18 if present. The heating elements 46 can be controlled by a controller to sequentially generate heat so that a heated area 44′ propagates across the outer surface 12 of the fluid ejector 10.

By selecting an appropriate timing of application of power to the heating elements to set the speed of propagation of the heated area 44′, in conjunction with the power to the heating elements 46, the cleaning fluid 32 is completely evaporated from the outer surface 12 along a front 60 that will sweep across the outer surface 12. In this implementation, it is not necessary to move the fluid ejector 10 while drying the area 44′, although a support 25 to hold the fluid ejector 10 and a motor 27 can still be present, e.g., to move the fluid ejector relative to the dispenser 30 or to carry the fluid ejector 10 from a printing position to a maintenance station.

In the implementations shown in FIGS. 4A-6B, the cleaning fluid can include a solvent and carrier liquid. However, in some implementations, the cleaning fluid does not include a carrier liquid. Optionally, the carrier liquid can be more wettable than the solvent to residue formed from dried fluid ejected the fluid ejector. Optionally, the carrier liquid can have a higher vapor pressure than the solvent.

Referring to FIG. 7, a method 110 of cleaning an outer surface 12 of a fluid ejector 10, applicable to all of implementations of FIGS. 4A-6B, includes dispensing the cleaning fluid 32 onto the outer surface 12 of the fluid ejector 10 (step 112). In some implementations the cleaning fluid 32 can include a solvent, e.g., DEGmBE, and a carrier liquid, e.g., water, but in some implementations, the cleaning fluid does not include a carrier liquid. If the cleaning fluid includes a carrier liquid, the carrier liquid can be more wettable to residue of fluid ejected from nozzles of the fluid ejector than the solvent, and can have a higher vapor pressure than the solvent.

A region of the outer surface 12 of the fluid ejector is dried (step 114). The region can be a linear stripe, and can extend perpendicular to the direction of relative motion between the fluid ejector and the heater. Drying can include blowing gas onto the outer surface, as shown by FIGS. 4A-4B, heating the outer surface with an external heater, as shown by FIGS. 5A-5B, or heating the outer surface with an internal heater, as shown by FIGS. 6A-6B.

The region is moved in a path across the outer surface of the fluid ejector to cause evaporation of the cleaning fluid along a front that moves across the outer surface of the fluid ejector (step 116).

Optionally, the outer surface 12 of the fluid ejector 10 can then be wiped, e.g., by an absorbent material or an elastomeric blade 50 (step 118). Because the residue can be carried along by the moving front 60 of the evaporating cleaning fluid 32, the residue can be deposited in a region of the outer surface 12 where wiping can be performed without risk or with reduced risk of damaging the nozzles or non-wetting coating around the nozzles. For example, wiping, if performed, can avoid the nozzles 11. Alternatively or in addition to wiping, e.g., prior to wiping, the outer surface 12 of the fluid ejector can be sprayed with another cleaning liquid, e.g., water.

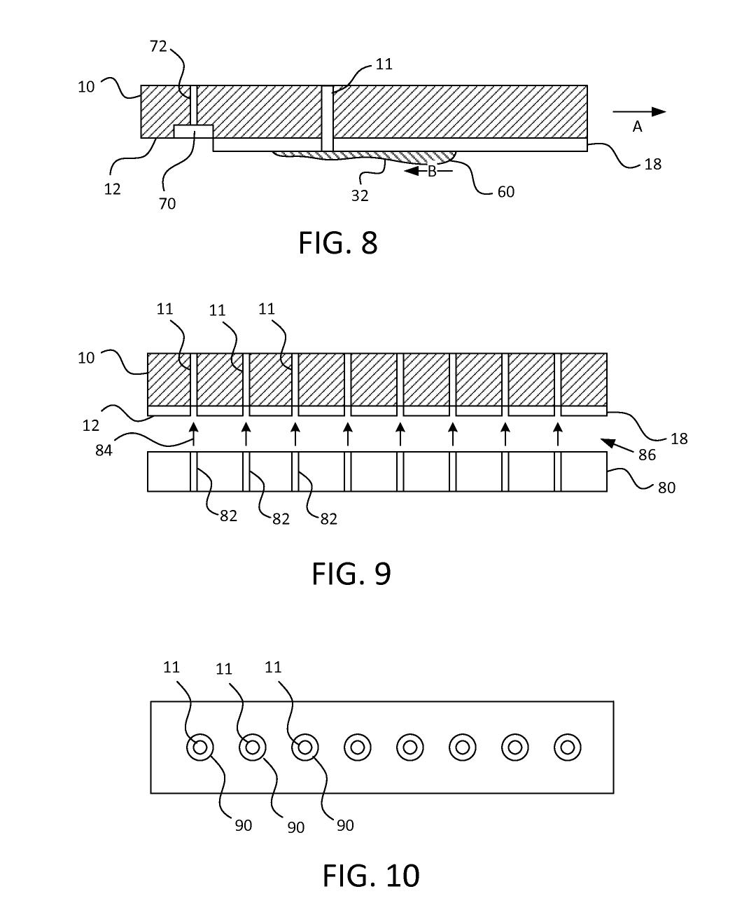

Referring to FIG. 8, in some implementations, which can be combined with any of the implementations of FIGS. 4A-6B, a gutter 70 can be formed in fluid ejector 10. The gutter 70 can be located along an edge of the fluid ejector 10. The gutter 70 can be recessed relative to the area of the outer surface 12 with the nozzles. Alternatively, or in addition, the gutter 70 can be more wettable than the area of the outer surface 12 with the nozzles, either due to surface treatment or surface texture. For example, the non-wetting coating 18 can be removed from or not formed in the gutter 70. The gutter 70 can be maintained at a slight negative pressure, e.g., by applying a vacuum through one or more passages 72 fluidically connected to the gutter 70, in order to suction away the cleaning fluid and any residue. The gutter 70 can be perpendicular to the direction of motion of the front 60. Optionally, the gutter 70 can be wiped intermittently, e.g., by an absorbent material or an elastomeric blade.

Referring to FIG. 9, in some implementations, a jet of drying gas 84 is directed at each nozzle 11 or along each row of nozzles in the outer surface 12 of the fluid ejector 10. For example, a plate 80 can be fabricated that has holes 82 in the same locations as the nozzles 11 in the fluid ejector 10. The plate 80 can be positioned adjacent and separated from the fluid ejector 10 by a gap 86, with the holes 82 laterally aligned with the nozzles 11. Dry and/or heated gas 84, e.g., dry air, can be forced through the holes 82 with a pressure sufficiently high to cause the cleaning fluid on the outer surface 12 to evaporate in regions that expand outwardly from the nozzles 11, thus carrying residue away from the nozzles 11, yet sufficiently low to avoid depriming the ink nozzles.

Referring to FIG. 10, in some implementations, the fluid ejector 10 can include a plurality of nozzles 11, and each nozzle 11 can be surrounded by a thin film heater 90. The heaters 90 can be activated to heat the nozzle plate to a temperature sufficient to cause the cleaning fluid on the outer surface 12 to evaporate in regions that expand outwardly from the nozzles 11, thus carrying residue away from the nozzles 11.

Example. A blow drier in the form of an air knife was positioned 1-2 mm above an outer surface of a nozzle plate that was covered with a cleaning fluid that included a 3:1 solution of water and DEGmBE. The temperature of the air stream from the air knife was estimated to be about 200 to 400° C. The air knife was moved at about 1-2 mm/sec across the outer surface of the fluid ejector to cause evaporation of the cleaning fluid along a front that moved at 1-2 mm/sec.

A number of embodiments of the invention have been described. Nevertheless, it will be understood that various modifications may be made without departing from the spirit and scope of the invention. For example, other components can be added to the cleaning fluid, e.g., a surfactant, e.g., polyether modified dimethylpolysiloxane, e.g., 0.5% by volume of BYK-333, available from BYK USA Inc. A motor can move the support 25 to carry the fluid ejector 10 from a printing position, where fluid will be ejected from the nozzle 11 for printing, to a maintenance station that includes the dispenser 30 and/or drier 40, where the cleaning will be performed. Accordingly, other embodiments are within the scope of the following claims.

What is claimed is:

1. A method of cleaning an outer surface of a fluid ejector, comprising:
dispensing a cleaning fluid onto the outer surface of the fluid ejector;
drying a region of the outer surface of the fluid ejector; and
moving the region in a path across the outer surface of the fluid ejector to cause evaporation of the cleaning fluid along a front that moves across the outer surface of the fluid ejector.

2. The method of claim 1, wherein movement of the front across the outer surface of the fluid ejector carries residue of fluid ejected from nozzles.

3. The method of claim 1, wherein the region is linear.

4. The method of claim 1, wherein the path across the outer surface of the fluid ejector is linear.

5. The method of claim 1, wherein the region is elongated along an axis perpendicular to a direction of motion of the front.

6. The method of claim 1, wherein drying comprises directing a gas at the front.

7. The method of claim 1, wherein drying comprises heating a portion of the outer surface adjacent the front.

8. The method of claim 7, wherein heating the portion of the outer surface comprises directing heated gas at the region.

9. The method of claim 7, wherein heating the portion of the outer surface comprises directing radiant heat at the region.

10. The method of claim 7, wherein heating the portion of the outer surface comprises generating heat from a heater embedded in the fluid ejector.

11. The method of claim 1, wherein the cleaning fluid includes a solvent and a carrier liquid.

12. The method of claim 11, wherein the carrier liquid has a higher vapor pressure than the solvent.

13. The method of claim 11, wherein the carrier liquid is more wettable to residue of fluid ejected by the fluid ejector than the solvent.

14. The method of claim 1, further comprising collecting the cleaning fluid in a gutter.

15. A method of cleaning a surface of a fluid ejector, comprising:
dispensing a cleaning fluid onto the outer surface of the fluid ejector, the cleaning fluid including a solvent and carrier liquid that is more wettable to residue of fluid ejected from nozzles of the fluid ejector than the solvent and having a higher vapor pressure than the solvent; and
evaporating the carrier liquid such that a concentration of solvent on the surface of the fluid ejector increases.

16. The method of claim 15, wherein the outer surface of the fluid ejector comprises a non-wetting coating.

17. The method of claim 16, wherein the carrier liquid is more wettable to the non-wetting coating than the solvent.

18. The method of claim 15, wherein evaporating the carrier liquid includes heating the cleaning fluid.

19. The method of claim 18, wherein heating the carrier liquid comprises directing heated gas at the cleaning fluid.

20. The method of claim 18, wherein heating the carrier liquid comprises directing radiant heat at the cleaning fluid.

21. The method of claim 18, wherein heating the carrier liquid comprises generating heat from a heater embedded in the fluid ejector.

22. The method of claim 15, wherein the carrier liquid is water.

23. The method of claim 22, wherein the carrier liquid is partially but not entirely evaporated.

24. The method of claim 15, further comprising wiping the outer surface with a contact wiper.

25. The method of claim 15, further comprising drying a region of the outer surface of the fluid ejector, and moving the region in a path across the surface of the fluid ejector to cause evaporation of the cleaning fluid along a front that moves across the outer surface of the fluid ejector.

26. An apparatus for cleaning an outer surface of a fluid ejector, comprising:
a cleaning fluid dispenser positioned to direct a cleaning fluid onto the outer surface of the fluid ejector;
a support to hold the fluid ejector;
a drier positioned to dry a region of the outer surface of the fluid ejector held by the support;
a motor coupled to at least one of the support or the drier to cause relative motion therebetween such that the region moves in a path across the surface of the fluid ejector; and
a controller connected to the drier and the motor to control the relative motion such that the cleaning fluid evaporates along a front that moves across the outer surface of the fluid ejector.

27. An apparatus for cleaning an outer surface of a fluid ejector, comprising:
a dispenser to direct a cleaning fluid onto the outer surface of the fluid ejector, the cleaning fluid including a solvent and carrier liquid that is more wettable to residue of fluid ejected from nozzles of the fluid ejector than the solvent and has a higher vapor pressure than the solvent; and
a drier arranged and configured to evaporate the carrier liquid such that a concentration of solvent on the surface of the fluid ejector increases.
